(19) United States
(12) Patent Application Publication
(10) Pub. No.: US 2014/0365430 A1
(43) Pub. Date: Dec. 11, 2014

(54) INFORMATION PROCESSING APPARATUS, SYSTEM, AND CONTROL METHOD

(71) Applicant: CANON KABUSHIKI KAISHA, Tokyo (JP)

(72) Inventor: Hirotaka Funayama, Kawasaki-shi (JP)

(21) Appl. No.: 14/298,775

(22) Filed: Jun. 6, 2014

(30) Foreign Application Priority Data
Jun. 11, 2013 (JP) 2013-122460

(51) Int. Cl. G06F 17/30

(52) U.S. Cl. CPC G06F 17/30091
USPC 707/609

(57) ABSTRACT

An information processing apparatus includes a reception unit, a first determination unit, a saving unit, a second determination unit, and a transmission unit. The reception unit receives a file and file information. The first determination unit determines, based on the file information, whether the file has been saved. The saving unit saves, if the first determination unit determines that the file has not been saved, the file and the file information while associating them with each other. The second determination unit determines, if the first determination unit determines based on the file information that the file has been saved, whether the saved identifier and a newly received identifier are the same. The transmission unit transmits, if the second determination unit determines that the identifier saved by the saving unit and the identifier newly received by the reception unit are the same, information indicating that the received file has been saved.

### BACKGROUND OF THE INVENTION

1. Field of the Invention

The present invention relates to an information processing apparatus that saves a file, a system, and a control method.

2. Description of the Related Art

Currently, there is a technique for storing data or taking an error exit without storing data after receiving the data.

In Japanese Patent Laid-Open No. 2000-112799, a technique has been disclosed in which, after data is received, a directory is created and the received data is stored if no directory exists, or the data is not stored and an error exit is taken if a directory exists.

In addition, as a mode of performing various processes using a server computer, there are techniques such as a cloud computing system and Software as a Service (SaaS).

### SUMMARY OF THE INVENTION

In the above-mentioned cloud computing system, a problem might arise in terms of treating a file.

For example, assume a system that is used in a single server or a cloud computing system and that receives a file and file information relating to the file. The assumed system can be used, for example, in a use case in which a file is received from a client and a notification of successful saving is transmitted to the client. In this system, if it is determined on the basis of the file information that the file has not been saved, the file is saved and information indicating that the file has been saved is transmitted. On the other hand, in the assumed system, in order to, for example, prevent a file from being overwritten, an error notification is transmitted if it is determined on the basis of the file information that the file has been saved.

Here, for example, an error notification is undesirably transmitted unintentionally in the assumed system in the following case. That is, if connection to a component that has transmitted a file becomes no longer available after the file and file information are received, information indicating that the file has been saved cannot be transmitted after the file is saved. Thereafter, since the component that has transmitted the file cannot obtain the information indicating that the file has been saved, the component transmits the same file and file information again as a retry. As a result, the assumed system receives the same file and file information again. In this case, since the assumed system has already saved the file and the file information that have been received again, the assumed system transmits an error notification. As a result, for example, the component that has transmitted the file cannot recognize that the file has been successfully saved, and accordingly cannot proceed to subsequent processes.

On the other hand, in Japanese Patent Laid-Open No. 2000-112799, neither reception of a file and file information relating to the file nor transmission of information indicating that the file has been saved is disclosed. Furthermore, in Japanese Patent Laid-Open No. 2000-112799, since an error exit is taken if there is a directory, the same problem as that in the case of the assumed system might arise.

According to the present invention, even if, for example, connection to a component that has transmitted a file becomes no longer available and a file is received again as described above, information indicating that the file has been saved can be transmitted.

Aspects of the present invention include an information processing apparatus having a reception unit configured to receive a file and file information that includes an identifier and that is relating to the file, a first determination unit configured to determine, based on the file information, whether the file has been saved, a saving unit configured to save, if the first determination unit determines based on the file information that the file has not been saved, the file and the file information including the identifier while associating the file and the file information including the identifier with each other, a second determination unit configured to determine, if the first determination unit determines based on the file information that the file has been saved, whether the identifier saved by the saving unit and an identifier newly received by the reception unit are the same, and a transmission unit configured to transmit, if the second determination unit determines that the identifier saved by the saving unit and the identifier newly received by the reception unit are the same, information indicating that the file received by the reception unit has been saved.

Further features of the present invention will become apparent from the following description of exemplary embodiments with reference to the attached drawings.

### BRIEF DESCRIPTION OF THE DRAWINGS

FIG. 1 is a diagram illustrating the overall configuration of a cloud system according to a first embodiment.

FIG. 2A is a diagram illustrating the hardware configuration of a client terminal or a server computer according to the first embodiment, and FIG. 2B is a diagram illustrating the software configuration of the client terminal according to the first embodiment.

FIG. 3 is a diagram illustrating the sequence of a process at a time when initial data is saved according to a fourth embodiment.

FIG. 4 is a diagram illustrating details of the hardware configuration of an image forming apparatus according to the first embodiment.

FIG. 5 is a diagram illustrating the software configuration of a scan service server according to the first embodiment.

FIG. 6 is a diagram illustrating the software configuration of a task service server according to the first embodiment.

FIG. 7 is a sequence diagram illustrating a scanning process according to the first embodiment.

FIG. 8 illustrates the outline of the system configuration of flow service servers according to the first embodiment.

FIG. 9 is a diagram illustrating a sequence of file saving in which an exception is generated.

FIG. 10 is a diagram illustrating a sequence of file saving in which an exception is generated.

FIG. 11 illustrates an example of job information held by a job management service server according to the fourth embodiment.

FIG. 12 is a diagram illustrating the software configuration of a job management service server according to the first embodiment.

FIG. 13 is a flowchart illustrating a process at a time when initial data is saved according to the fourth embodiment.

FIG. 14 is a diagram illustrating the overall configuration of file management service servers according to the first embodiment.

FIG. 15 illustrates the software configuration of each of the file management service servers according to the first embodiment.

FIG. 16A illustrates an example of file server information according to the first embodiment, and FIG. 16B illustrates an example of file path information according to the first embodiment.

FIG. 17 is a flowchart illustrating a process at a time when a temporary file is saved according to the first embodiment.

FIG. 18 is a diagram illustrating the sequence of a process at a time when the temporary file is saved according to the first embodiment.

FIG. 19 is a flowchart illustrating a process for registering an entry to the file path information according to a second embodiment.

### DESCRIPTION OF THE EMBODIMENTS

In cloud computing, requests from a lot of clients can be simultaneously processed by executing data conversion and data processing in a distributed manner using a lot of computing resources. Furthermore, in order to utilize the characteristics of the cloud computing, a method for processing a large number of jobs in a scalable manner by realizing a series of processes in a server using strictly specified coupling of tasks and processing the tasks in parallel with one another will be examined hereinafter.

The tasks herein refer to processing content configuring jobs or software processes for realizing the processing content.

At this time, in a job processing mechanism, it is possible that a temporary file to be processed in a first task and a temporary file generated as a result of processing in each task create replications thereof in a plurality of file servers in order to secure usability.

Assume a job management service server that controls a job configured by one or more tasks, information and order of execution regarding the job, and the like. In each task, a plurality of instances can be generated. In each instance, a job is asynchronously obtained from the job management service server, and, for example, image processing such as removal of black spots, a process for storing data in a shared folder, or the like is performed. Binary data used in each task is managed by file management service servers. In each task, data to be processed is obtained from the file management service servers as necessary, and a result of processing is saved. An application for inputting a job to the job management service server will be referred to as a service application herein.

A service application inputs a job to the job management service server while inputting data to be processed to the file management service servers. The data input to the file management service servers at the same time as the input of a job will be referred to as initial data herein. In addition, data is information included in a file.

Overwriting of the initial data is prohibited so that the data can be obtained and the data is not overwritten and deleted by mistake after the saving. As a result, it becomes possible to prevent the initial data from being overwritten and lost by mistake. Since the initial data is not lost by mistake, the usability of a system can be improved by resuming processing on the basis of the initial data even if a failure or the like occurs in the server insofar as the initial data can be obtained. In addition, the usability further improves by saving the initial data in the plurality of file servers.

Information regarding a file including the initial data saved in a file server is separately managed by a database. If a process for saving a file is performed on a file saving application program interface (API) for which overwriting is prohibited, an exception (error) is generated from the server since the file already exists. Upon the generation of the exception, the application determines whether or not an instruction issued thereby has been appropriately executed. That is, it is desirable that an exception is appropriately generated because the exception affects subsequent processes performed by the application. Cases in which an exception is to be generated will be examined using the following two cases. In the first case, an exception is generated when a process that is not assumed by the system has been performed.

First, a case will be described in which an exception is generated when a third party has attempted to save a file that is exactly the same as a file already saved by a client.

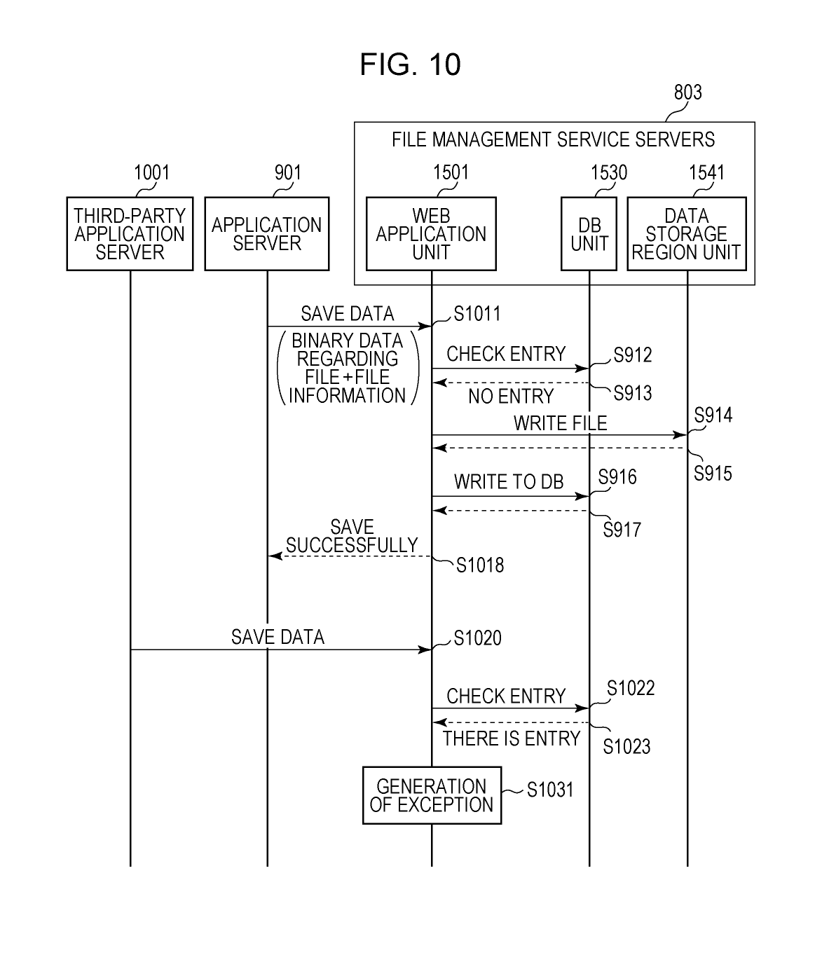

This case will be described in detail with reference to a sequence illustrated in FIG. 10. In FIG. 10, an application server 901 makes a file saving request to a web application unit 1501, which is one of the functions of file management service servers 803. Thereafter, a third-party application server 1001 makes a file saving request to the web application unit 1501 in order to save the same file as the file already saved by the application server 901.

It is to be noted that the functions of the file management service servers 803 described in the following description may be realized by a single server or a single virtual server, or may be realized by a plurality of servers or a plurality of virtual servers.

In addition, file information (details will be described later) saved to the web application unit 1501 is managed by a database (DB) unit 1530, and the file is stored in a data storage region unit 1541.

When making a data saving request in S1011, the application server 901 transmits binary data regarding a file to be saved and file information to the web application unit 1501. Upon receiving the data saving request, the web application unit 1501 inquires of the DB unit 1530 in S912 whether or not the same entry already exists.

It is to be noted that file information managed by a database (here, the DB unit 1530) that manages files will be referred to as entries herein.

Next, in S913, the DB unit 1530 returns a response indicating no entry (a process when there is an entry is omitted here). Next, the web application unit 1501 writes the file to the data storage region unit 1541 in S914. The web application unit 1501 then adds an entry to the DB unit 1530 in S916, and obtains a response in S917. In S1018, the web application unit 1501 returns a successful saving response to the application server 901.

Thereafter, the third-party application server 1001 makes a data saving request S1020 to the web application unit 1501 using the same file and file information as those in S1011. Upon receiving the data saving request, the web application unit 1501 inquires of the DB unit 1530 in S1022 whether or not the same entry already exists. At this time, since the entry has been written to the DB in S916, the DB unit 1530 returns a response S1023 indicating that there is an entry. Therefore, the web application unit 1501 determines that the data saving request S1020 is an overwriting request for a file for which an entry already exists, and generates an exception in S1031.

As in this case, if overwriting of a file that has been transmitted by the application server 901 and that has already been saved is to be prohibited, an exception is generated for a data saving request from the third-party application server 1001 in order to prevent the file from being overwritten. As a result, it becomes possible to prevent the file from being unintentionally overwritten.

The second case is a case in which communication between a client and a server is timed out while the server is saving a file, and then the client performs a retry process because no response has been returned to the client although the server has continued processing and successfully saved the file. In this case, an exception is not to be generated, but the same processing as in the first case is performed, thereby undesirably generating an exception.

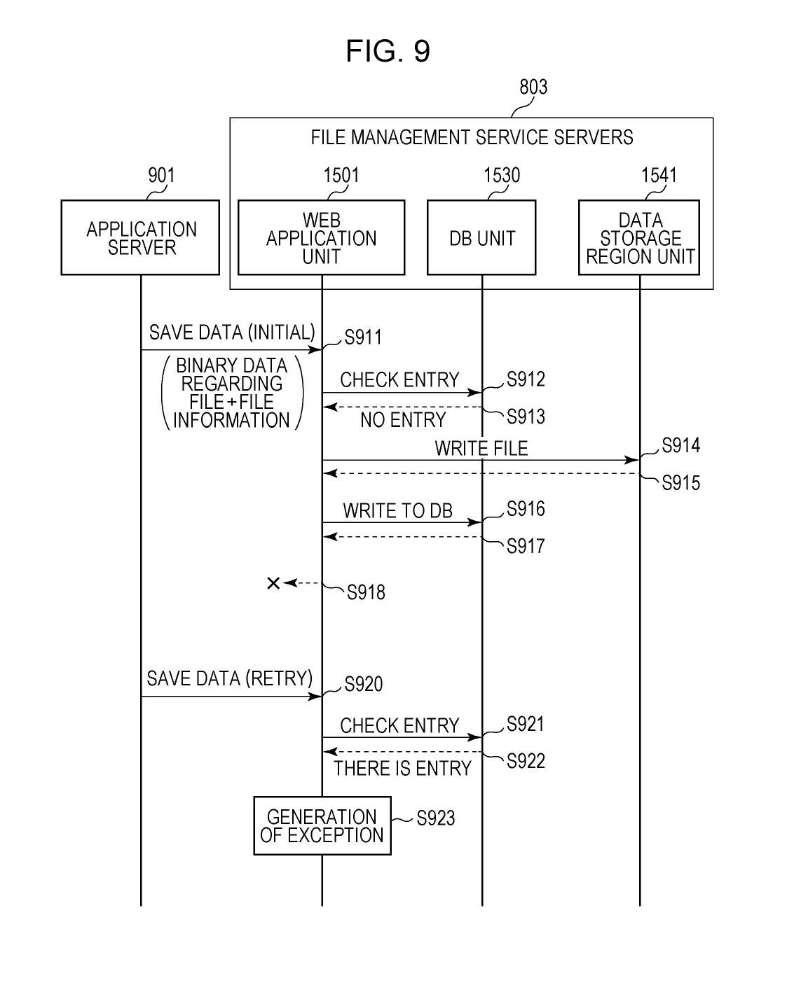

This case will be described in detail with reference to a sequence illustrated in FIG. 9.

It is to be noted that the same processing as that in the steps that have already been described is given the same reference numerals as those given to the steps that have been already been described, and accordingly description thereof is omitted.

When making an initial data saving request in S911, the application server 901 transmits binary data regarding a file to be saved and file information to the web application unit 1501. After the processing in S912 to S917, connection between the application server 901 and the web application unit 1501 is timed out in the example illustrated in FIG. 9. The reason for the timeout is mainly that when the file size of the binary data is large or when the transfer speed of a network in the file management service servers 803 is low, the time taken for the processing in S914 and S916 to be completed becomes longer than a timeout period. As a result of the timeout, the web application unit 1501 cannot return the response S918 to the application server 901. As a result, the application server 901 determines that the file transmitted in S911 has not been saved in the file management service servers 803, and performs a retry process for saving the data in S920.

Upon receiving the retry of the data saving request, the web application unit 1501 inquires of the DB unit 1530 in S921 whether or not the same entry already exists. At this time, since the entry has been written to the DB in S916, the DB unit 1530 returns a response S922 indicating that there is the entry. As a result, the web application unit 1501 determines the data saving request S920 as an overwriting request for a file for which an entry already exists, and generates an exception in S923 to stop the process.

If an exception is generated in such a case, however, the application server 901 undesirably receives an exception each time the application server 901 retries saving of data. Therefore, the application server 901 can never recognize that the file has been successfully saved.

In embodiments that will be described hereinafter, an exception is generated at an appropriate timing by generating the exception in a first case and returning a response indicating successful completion in a second case. As a result, a desirable response is returned to the client in response to a saving request.

### First Embodiment

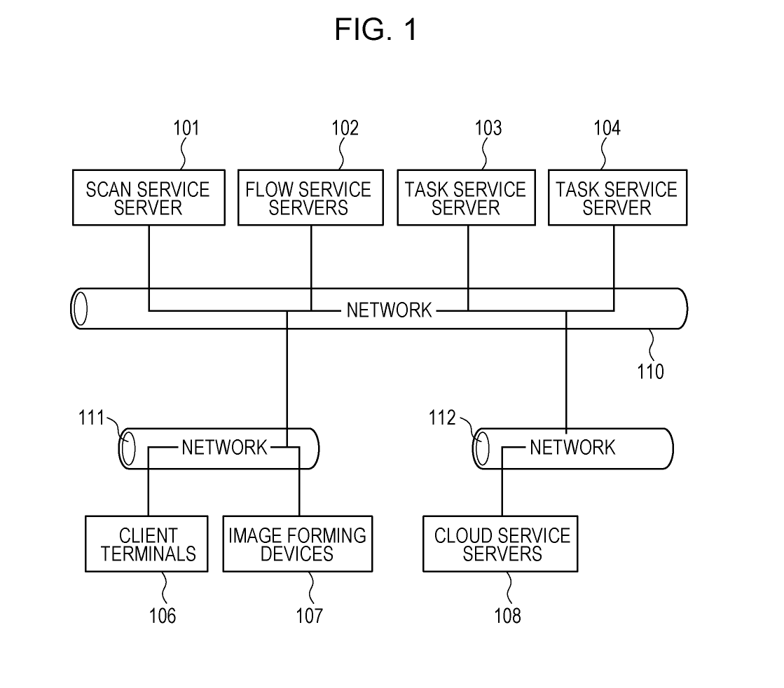

FIG. 1 is a diagram illustrating the overall configuration of a cloud system according to an embodiment of the present invention.

In FIG. 1, a scan service server 101, flow service servers 102, task service servers 103 and 104, client terminals 106, image forming apparatuses 107, and cloud service servers 108 are connected to one another through networks 110 to 112. It is assumed in the figure that a plurality of task service servers 103 and 104, client terminals 106, image forming apparatuses 107, and cloud service servers 108 are connected. Each of the networks 110 to 112 is, for example, a so-called communication network realized by any of a local area network (LAN) of the Internet or the like, a wide area network (WAN), a telephone line, a dedicated digital line, asynchronous transfer mode (ATM), a frame relay line, a cable television line, a data broadcast radio link, and the like, or a combination of some of these. It is only necessary that the networks 110 to 112 are capable of transmitting and receiving data. The networks 110 and 112 herein are the Internet, and the network 111 herein is an in-house network or a network provided by a service provider. The scan service server 101, the flow service servers 102, and the task service servers 103 and 104 are executed by virtual servers on a server computer, and these service servers provide cloud services for users. In addition, the cloud service servers 108 are put on the Internet and executed on a server computer.

The functions of each of the servers that will be described hereinafter may be realized by a single server or a single virtual server, or may be realized by a plurality of servers or a plurality of virtual servers. Alternatively, a plurality of servers may be executed on a single server as virtual servers.

Each of the client terminals 106 is, for example, a desktop personal computer, a laptop personal computer, a mobile personal computer, a personal digital assistant (PDA), or the like, but may be a mobile phone including an environment for executing programs. Each of the client terminals 106 includes an environment for executing programs of a web browser (an Internet browser or a WWW browser; a browser for using the World Wide Web) or the like.

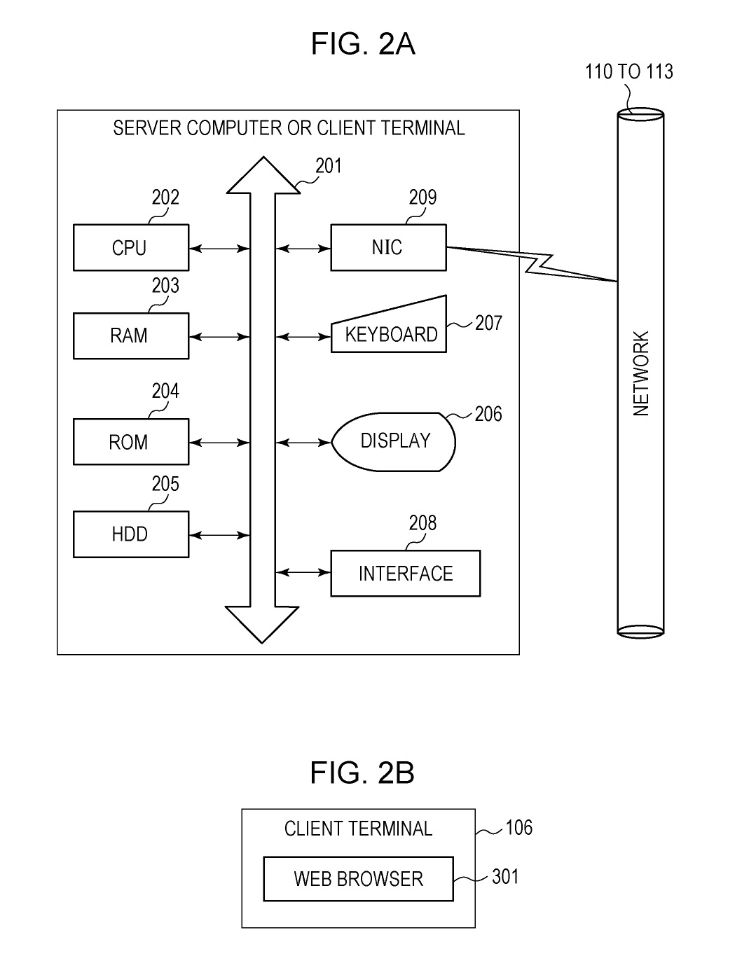

FIG. 2A is a diagram illustrating the hardware configuration of each of the client terminals 106, the service servers 101 to 104, and the cloud service servers 108 (information processing apparatuses).

In FIG. 2A, a central processing unit (CPU) 202 controls the entirety of the apparatus. The CPU 202 executes application programs, an OS, and the like stored in a hard disk drive (HDD) 205, and performs control for temporarily storing information, a file, or the like necessary to execute a program in a random-access memory (RAM) 203. A read-only memory (ROM) 204 is a storage unit that stores various pieces of data such as a basic input/output (I/O) program therein. The RAM 203 is a temporary storage unit and functions as a main memory, a work area, or the like of the CPU 202. The HDD 205 is one of external storage units and functions as a large-capacity memory that stores application programs of a web browser or the like, programs of the service servers, an OS, related programs, and the like. A display 206 is a display unit that displays a command or the like input from a keyboard 207. An interface 208 is an external apparatus interface (I/F) that connects a printer, a Universal Serial Bus (USB) device, or a peripheral device. The keyboard 207 is an instruction input unit. A system bus 201 controls the flow of data in the apparatus. A network interface card (NIC) 209 communicates data with external apparatuses therethrough and through the networks 110 to 112. It is to be noted that the above configuration of each computer is just an example, and is not limited to the example of the configuration illustrated in FIG. 2A. For example, data and programs may be stored in any of the ROM 204, the RAM 203, the HDD 205, and the like in accordance with the characteristics thereof.

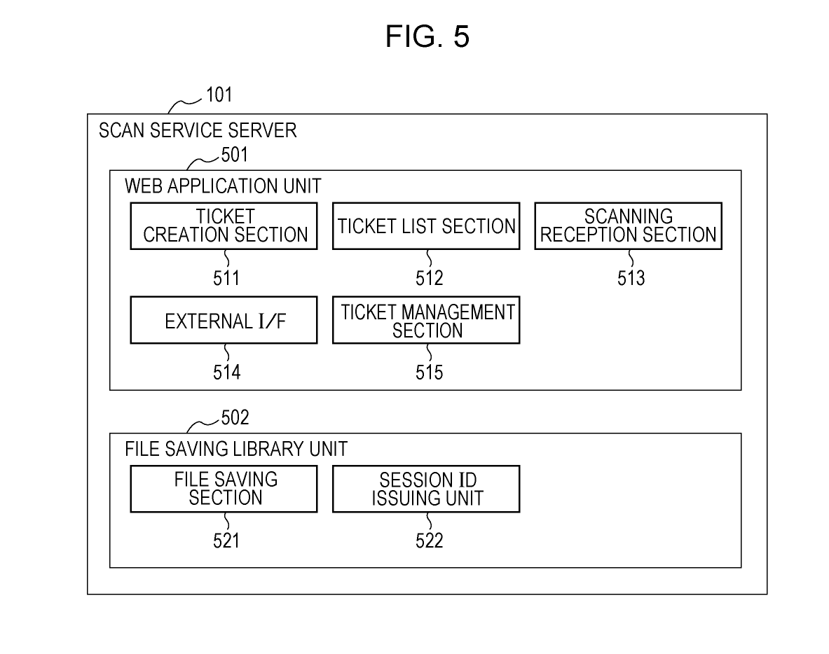

In addition, a software configuration illustrated in FIG. 5 or the like and processing in each step of flowcharts that will be referred to later are realized by the CPU 202 by executing processes on the basis of the programs stored in the HDD 205.

FIG. 2B is a diagram illustrating the software configuration of each of the client terminals 106 according to this embodiment of the present invention. In FIG. 2B, transmission of a request to a web application provided by the scan service server 101, display of a response, and the like are performed using a web browser 301. A user who uses the cloud services uses the cloud services using the web browser 301 of the client terminal 106.

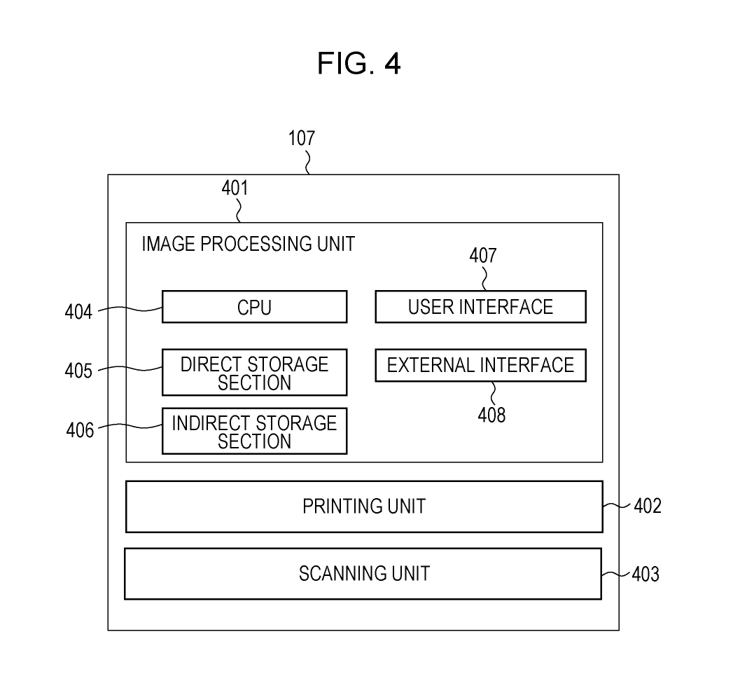

FIG. 4 is a block diagram illustrating the hardware configuration of each of the image forming apparatuses 107 according to this embodiment of the present invention. Although an apparatus having both scanning and printing functions will be taken as an example in this embodiment, a scanning device without a printing function may be used to realize a scan service.

In FIG. 4, the image forming apparatus 107 includes an image processing unit 401, a printing unit 402, and a scanning unit 403. The image processing unit 401 includes a CPU 404, a direct storage section 405, an indirect storage section 406, a user interface 407, and an external interface 408.

The CPU 404 is a unit that executes certain programs and specifies various types of control performed by the image forming apparatus 107. The direct storage section 405 is a working memory used by the CPU 404 to execute a program, and the program to be executed by the CPU 404 is loaded into the direct storage section 405. The direct storage section 405 is realized by a RAM. The indirect storage section 406 stores various programs including application programs and platform programs. Various programs stored in the indirect storage section 406 are moved to the direct storage section 405 before the CPU 404 executes these programs. The indirect storage section 406 is realized by a solid-state drive (SSD) or an HDD. In addition, the CPU 404 may be a multiprocessor.

Here, a platform realized by a platform program will be described in detail. By realizing a platform, a new original application developed by a user can be executed on the image forming apparatus 107, and an operation screen of the image forming apparatus 107 can be customized.

A method for realizing a platform will be described. The CPU 404 moves a platform program stored in the indirect storage section 406 to the direct storage section 405. After the movement, the CPU 404 can execute the platform program (for example, Java (registered trademark)). In this embodiment of the present invention, execution of a platform program by the CPU 404 will be referred to as activation of a platform. It is to be noted that the platform operates on firmware of the image forming apparatus 107. A platform program provides an environment for executing an application program described in an object-oriented manner.

A method for executing an application program on the platform will be described in detail. In this embodiment of the present invention, scanning software for transmitting a scanned image to a cloud service is operating on the platform. The scanning software receives a list of scan tickets from the scan service server 101 connected through a network using, for example, a communication protocol such as a Hypertext Transfer Protocol (HTTP). In each scan ticket, information such as settings for scanning and subsequent processing flows is recorded. A software unit realized by executing scanning software will be referred to as a scanning software unit. A user can complete scanning by selecting a scan ticket from the list of scan tickets displayed on the scanning software unit and causing the scanning software unit to read a document. The scanning software unit transmits information regarding the scan ticket selected by the user and scanned image data to the scan service server 101. Thus, by executing an application program on the platform, control of the image forming apparatus 107 can be realized.

A method for executing an application program will be described. An activated platform moves an application program stored in the indirect storage section 406 to the direct storage section 405. When the movement has been completed, the platform can execute the application program. The platform executes the application program. Thus, a function of the platform provided by executing an application program will be referred to as a platform application in this embodiment of the present invention. Furthermore, the platform can execute part of processing illustrated in the flowcharts disclosed in this embodiment of the present invention.

Returning to the description with reference to FIG. 4, the user interface 407 is a unit necessary to receive a processing request from the user. For example, the user interface 407 receives, through a touch panel, a keyboard, a mouse, or the like, a signal according to an instruction input by the user. The external interface 408 is capable of receiving data from external apparatuses and transmitting data to the external apparatuses. For example, the external devices include external storage devices such as external HDDs and external USB memories and separate apparatuses such as separate host computers and image forming apparatuses connected through networks. The image forming apparatuses 107 can communicate with the client terminals 106 and the scan service server 101 through the networks 110 and 111.

Next, the service servers including the scan service server 101 and the task service servers 103 and 104 that provide the cloud services will be described.

The scan service server 101 will be described with reference to FIG. 5. The scan service server 101 is a service that provides a scanning function in the cloud services. FIG. 5 is a diagram illustrating the software configuration of the scan service server 101 according to this embodiment of the present invention. The scan service server 101 includes a web application unit 501 and a file saving library unit 502. By executing various processes using these components, the scan service server 101 is provided for the users.

The web application unit 501 provides an application program that provides the scanning function. A ticket creation section 511 realizes a series of functions for enabling the users to create scan tickets. In each scan ticket, settings when the image forming apparatus 107 scans a document, the definitions of subsequent processing flows, parameters for tasks performed in each processing flow, and the like are recorded.

An external I/F 514 communicates with the scanning software unit operating on the image forming apparatus 107. The scanning software unit accesses the functions of a ticket list section 512 and the functions of a scanning reception section 513 through the external I/F 514.

The file saving library unit 502 is a library used for saving data in the flow service servers 102. Details will be described later.

The scanning reception section 513 receives a transmitted scan ticket and image data, and then transmits the image data to a file saving section 521.

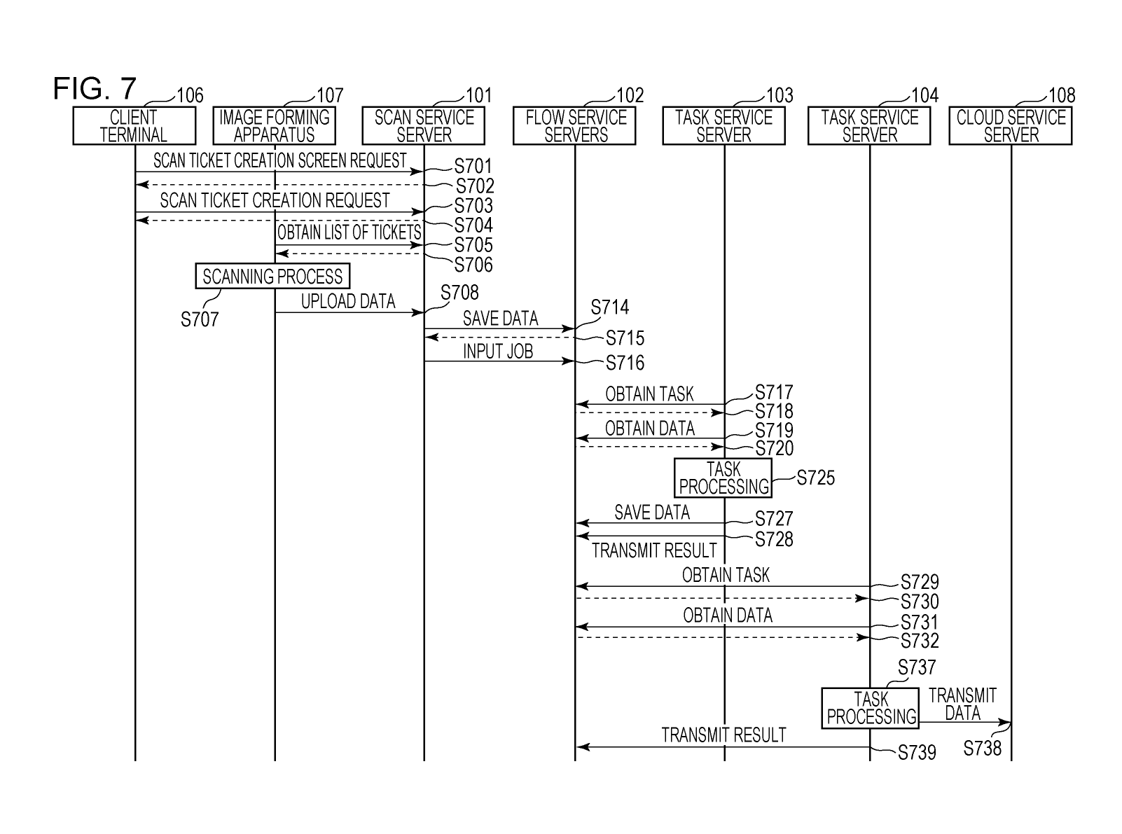

A procedure performed until a scan job is input will be described with reference to FIG. 7. First, a procedure performed until a scan ticket is created and a scan job is input will be described with respect to a scanning process.

In FIG. 7, upon receiving a scan ticket creation screen request S701 from the web browser 301 of the client terminal 106, the ticket creation section 511 generates a can ticket creation screen and makes a response S702. By operating the web browser 301 of the client terminal 106, the user makes a scan ticket creation request S703 in order to request creation of a scan ticket and saving of the created scan ticket in the ticket management section 515. After saving ticket information, the ticket management section 515 makes a response S704.

In FIG. 7, the scanning software unit of the image forming apparatus 107 obtains a list of tickets S705 from the ticket list section 512 through the external I/F 514. The ticket list section 512 generates a list of scan tickets from the ticket management section 515, and returns a response S706 to the scanning software unit. Upon receiving the response, the image forming apparatus 107 displays the obtained list of tickets on the user interface 407 illustrated in FIG. 4.

In a scanning process S707 illustrated in FIG. 7, the user selects one of the tickets displayed on the user interface 407. The user then disposes a sheet on a scanning device included in the image forming apparatus 107 and executes scanning. As a result, in scanning transmission S708, the scanning software unit transmits scanned image data and the scan tickets to the scanning reception section 513 through the external I/F 514.

In data saving S714, the image data is input to the flow service servers 102. In the data saving S714, the file saving section 521 inputs file information including a session identifier (ID) issued by the a session ID issuing unit 522 to the flow service servers 102 along with the image data.

The session ID is an identifier issued for each session, and a different identifier is used for connection each time data saving is performed in S714.

The file information will be described later. As a result, the file management service servers 803 of the flow service servers 102 receive the file (the image data in this embodiment) and the file information relating to the file. If communication between the file saving section 521 and the flow service servers 102 fails in the data saving S714 due to a timeout or the like, a retry process is performed using the same session ID as the previous one for the file information. However, a session ID different from that in the initial connection may be used for connection in the retry process, instead.

The retry process is performed three times in this embodiment. In addition, although omitted in FIG. 7, the image forming apparatus 107 is notified of a failure if the data saving S714 fails three times, and the process ends. If the image data can be correctly received, the flow service servers 102 return an ID (file group ID) uniquely indicating the image data to the scan service server 101. Thereafter, the scanning reception section 513 transmits the file group ID, the scan ticket, and a tenant ID to the flow service servers 102 in a job input request S716. Here, the tenant ID is an ID unique to each tenant indicating a tenant to which the user who has input the job belongs.

The system configuration of the scan service server 101 and the procedure performed until a scan job is input have been described.

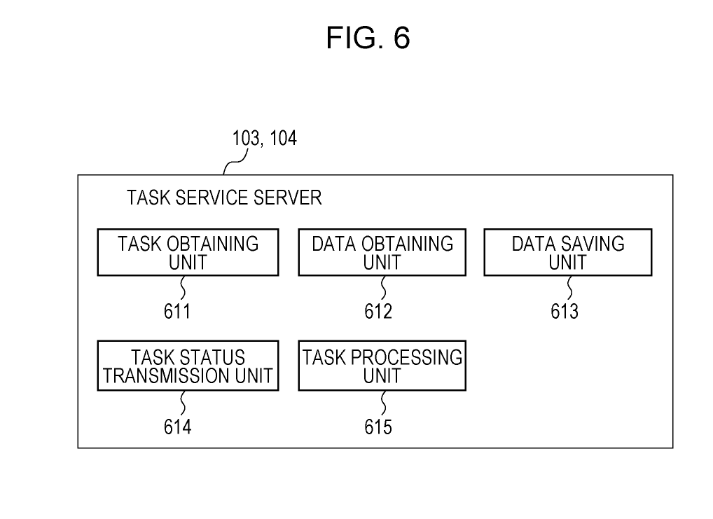

Again, the software configuration of the task service servers 103 and 104 according to this embodiment of the present invention will be described with reference to FIG. 6. Each task service server is a service server that realizes elements and functions for realizing a scan service. For example, there are a task service server that performs image processing on image data and a task service server that performs a process for transmitting image data to another cloud service server 108 that provides a function of sharing files. In this embodiment, the task service server 103 performs an optical character recognition (OCR) process on image data and a process for embedding text data, which is a result of the OCR process, in image data. The task service server 104 performs a process for uploading and storing image data for a particular service in the cloud service servers 108 that provides a storage function.

Each component will be described hereinafter along with a procedure illustrated in a sequence diagram of the scanning process in FIG. 7.

Task obtaining units 611 of the task service servers 103 and 104 regularly make inquiries to the flow service servers 102 in S717 and S729, respectively, and obtain tasks that can be processed by the task service servers 103 and 104. Data obtaining units 612 of the task service servers 103 and 104 obtains image and text data to be processed from the flow service servers 102 in S719 and S731, respectively, on the basis of job information obtained by the task obtaining units 611. Task processing units 615 of the task service servers 103 and 104 perform various processes on the obtained image data in S725 and S737, respectively. A data saving unit 613 saves data processed in S725 in the flow service servers 102 in S727.

The task processing unit 615 of the task service server 104 transmits data regarding a result of the processing in S737 to the cloud service servers 108 in S738.

Task status transmission units 614 of the task service servers 103 and 104 transmit results of the series of task processes to the flow service servers 102 in S728 and S739, respectively.

Thus, the series of processes of the scan job are completed.

Next, the flow service servers 102 will be described in detail. The flow service servers 102 are main service servers in the present invention, and are service servers that perform route management, job management, and temporary file management.

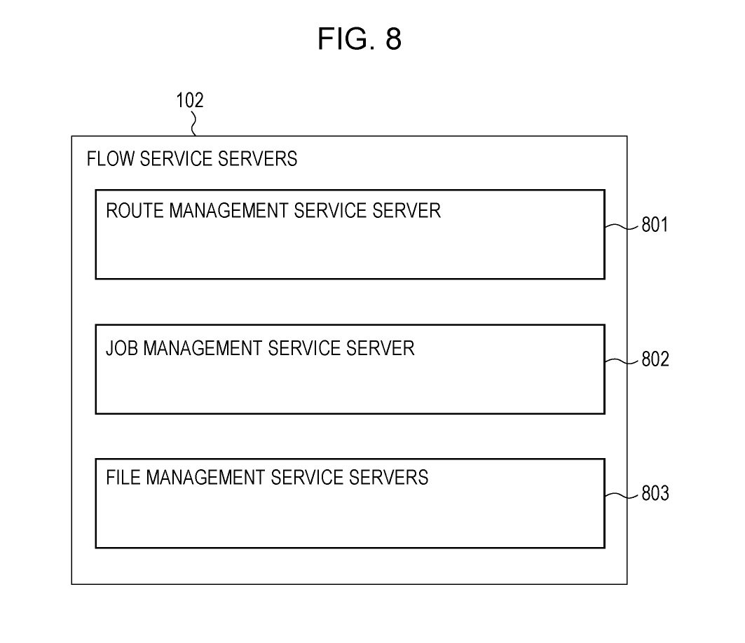

FIG. 8 illustrates the outline of the system configuration of the flow service servers 102.

The flow service servers 102 include a route management service server 801, a job management service server 802, and the file management service servers 803. Services are provided by executing various processes on these service servers and combined to provide a flow service for the users.

The route management service server 801 manages information regarding a route connecting tasks. The job management service server 802 manages processing of a job on the basis of the information regarding a route. The file management service servers 803 save and manage data at the time of input of a job and data regarding a result of processing in each task.

Next, the job management service server 802 and the file management service servers 803 included in the flow service servers 102 will be described in detail.

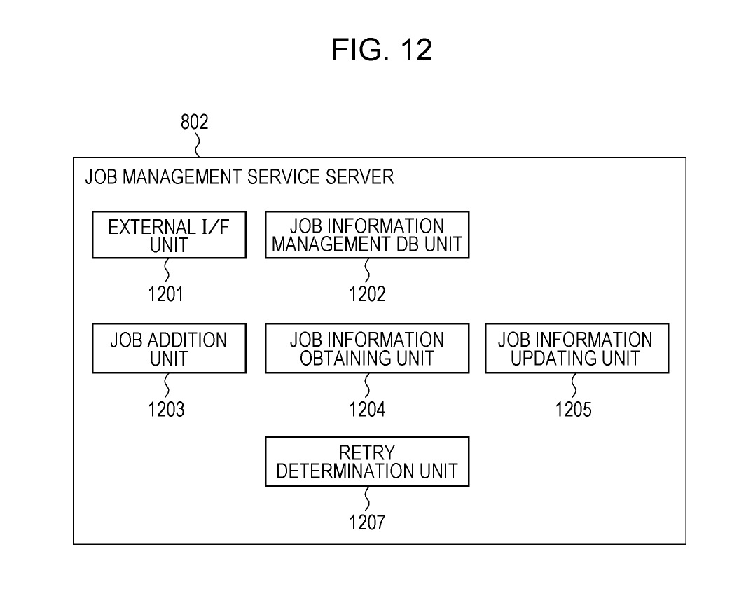

The software configuration of the job management service server 802 will be described with reference to FIG. 12. The job management service server 802 is a service server for transmitting and receiving task information in accordance with requests from the task service servers 103 and 104 and managing the state of each task.

An external I/F unit 1201 communicates with the task service servers 103 and 104 and the scan service server 101. Each function of the job management service server 802 is accessed through the external I/F unit 1201. A job information management DB unit 1202 manages the status of each created job and an ID of data used in each job. Upon receiving the job input request S716 illustrated in FIG. 7 issued from the scan service server 101 through the external I/F unit 1201, a job addition unit 1203 stores job information in the job information management DB unit 1202. Here, the job information refers to information associated with each job existing in the job information management DB unit 1202. Upon receiving the task obtaining requests S717 and S729 issued from the task service servers 103 and 104, respectively, through the external I/F unit 1201, a job information obtaining unit 1204 obtains the job information from the job information management DB unit 1202. The job information obtained here is transferred to the task service servers 103 and 104 in responses S718 and S730. Upon receiving job information update requests issued from the task service servers 103 and 104 through the external I/F unit 1201 in the transmission of results S728 and S739, respectively, a job information updating unit 1205 updates information regarding corresponding jobs in the job information management DB unit 1202.

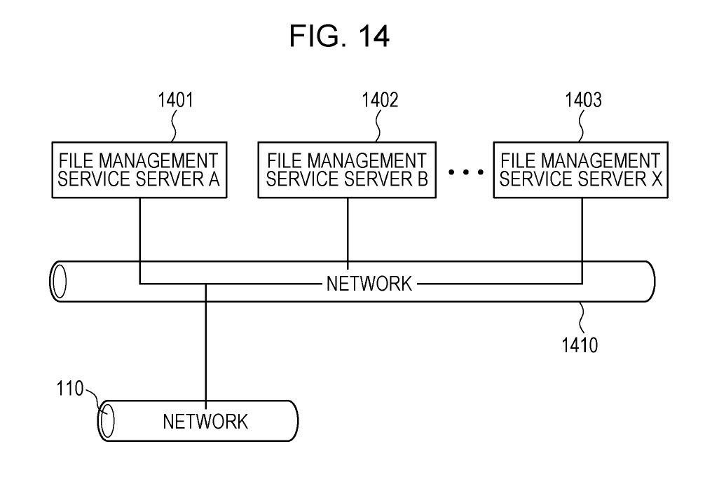

Next, the file management service servers 803 will be described with reference to FIGS. 14, 15, 16A, 16B, and 17.

FIG. 14 is a diagram illustrating the overall configuration of the file management service servers 803. In FIG. 14, a file management service server A 1401 to a file management service server X 1403 are connected to one another through a network 1410. Any number of servers may be used for the file management service server A 1401 to the file management service server X 1403 insofar as the number is a natural number. In addition, the network 1410 is connected to the network 110. As with the network 110, the network 1410 is a communication network capable of transmitting and receiving data.

It is to be noted that the file management service server A 1401 to the file management service server X 1403 may be executed as virtual servers on a single server computer or a plurality of server computers. When the file management service server A 1401 to the file management service server X 1403 are executed as virtual servers on a single server computer, the network 1410 is realized by a system bus on the server computer.

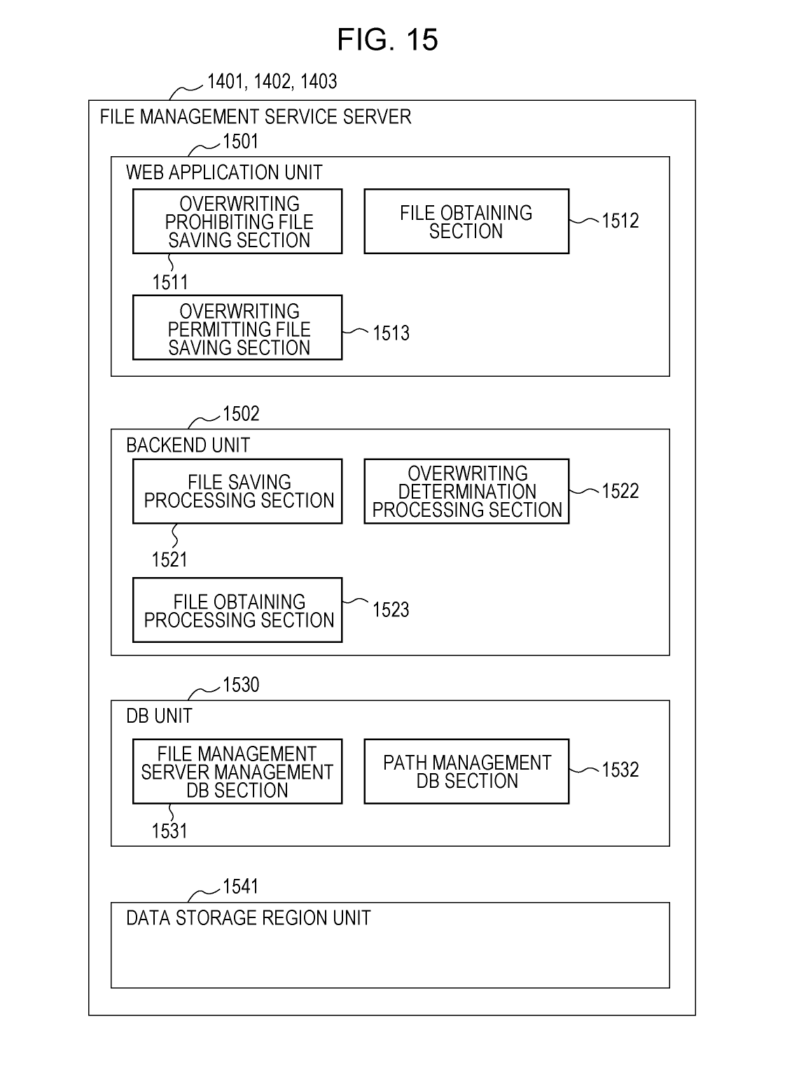

Next, the file management service server A 1401 to the file management service server X 1403 that provide a temporary file management function will be described with reference to FIGS. 15, 16A, 16B, and 17.

FIG. 15 is a diagram illustrating the software configuration of the file management service server A 1401 to the file management service server X 1403 according to this embodiment of the present invention. Each of the file management service server A 1401 to the file management service server X 1403 includes the web application unit 1501, a backend unit 1502, the DB unit 1530, and the data storage region unit 1541. The DB unit 1530 includes a file management service server management DB section 1531 and a path management DB section 1532. Services are provided by executing various processes using these components.

The file management service server management DB section 1531 manages information regarding each of the file management service server A 1401 to the file management service server X 1403, in which files are stored.

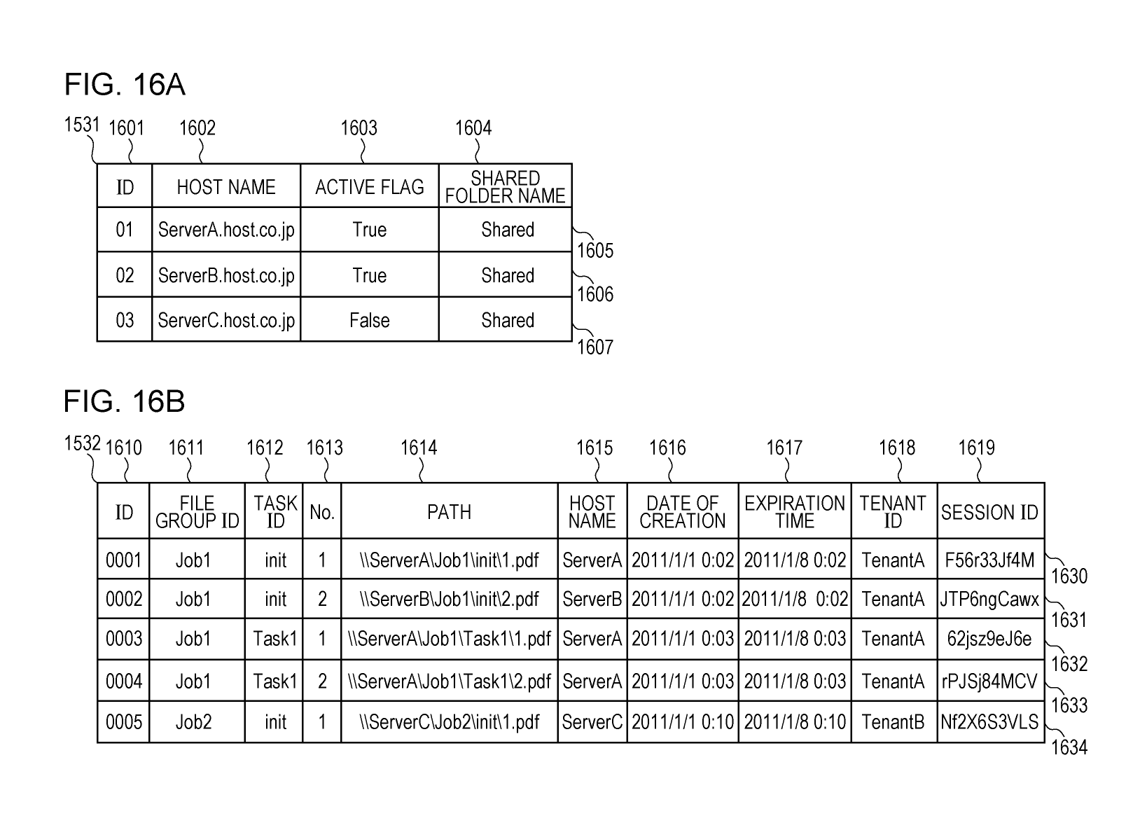

FIG. 16A illustrates an example of data managed by the file management service server management DB section 1531. An ID 1601 is information for uniquely identifying a file management service server among the file management service servers 803. A host name 1602 indicates a unique address of a file management service server in the network 1410. An active flag 1603 is a truth value indicating whether or not communication with a file management service server having the host name 1602 is possible. If possible, the active flag 1603 indicates “true”, and if not, the active flag 1603 indicates “false”. A shared folder name 1604 indicates a folder existing on the file management service server A 1401 to the file management service server X 1403. The data storage region unit 1541 is a folder indicated by the shared folder name 1604.

The path management DB section 1532 manages information regarding temporary files saved in the data storage region unit 1541 of each of the file management service server A 1401 to the file management service server X 1403, the temporary files being managed by the file management service servers 803, as entries.

A temporary file refers to initial data saved from the scan service server 101 and a file generated as a result of processing performed by the task service servers 103 and 104.

FIG. 16B illustrates an example of entries managed by the path management DB section 1532.

A file ID 1610 is information for uniquely identifying an entry in each of the file management service server A 1401 to the file management service server X 1403.

A file group ID 1611 is information for grouping each entry using a related job. Therefore, entries generated in the same job have the same file group ID 1611. The value of a task ID 1612 is either a task ID for identifying a task relating to a temporary file corresponding to each entry or “init”, which indicates initial data. A No. 1613 indicates a file number of a temporary file generated in each task. An arbitrary number is provided as the No. 1613 by the scan service server 101 in this embodiment.

A path 1614 indicates a full path of a storage of a temporary file corresponding to each entry and is used when the web application unit 1501 accesses an entity through the backend unit 1502. A host name 1615 indicates a host name of a file management service server that stores a temporary file corresponding to each entry. A date of creation 1616 indicates a time at which a temporary file has been stored in the data storage region unit 1541. An expiration time 1617 indicates an expiration time of a temporary file, and a temporary file corresponding to an entry whose expiration time 1617 has come is deleted. A tenant ID 1618 indicates a tenant ID of a tenant to which a user who has saved a temporary file belongs. A session ID 1619 indicates a session ID used when a file has been saved. For example, a session ID issued by the scan service server 101 in the data saving S714 is stored.

Next, the functions of the web application unit 1501 will be described.

An overwriting prohibiting file saving section 1511 realizes a function of multiplexing and saving a file in the data storage region unit 1541 of each of the file management service server A 1401 to the file management service server X 1403 while prohibiting overwriting in accordance with a request from the scan service server 101. The request from the scan service server 101 includes information relating to a file to be saved, such as the task ID 1612, the No. 1613, the expiration time 1617, the tenant ID 1618, the session ID 1619, and the like, which are managed as an entry of the path management DB section 1532. In addition, if an exception such as a communication error is generated when the scan service server 101 is making a request to the overwriting prohibiting file saving section 1511, the scan service server 101 can perform the retry process.

As described with reference to the processing in S714 illustrated in FIG. 7, the scan service server 101 transmits a request configured by file information including a session ID issued by the session ID issuing unit 522 and a temporary file to the overwriting prohibiting file saving section 1511. Upon receiving the file saving request, the overwriting prohibiting file saving section 1511 transmits the file information to an overwriting determination processing section 1522 of the backend unit 1502.

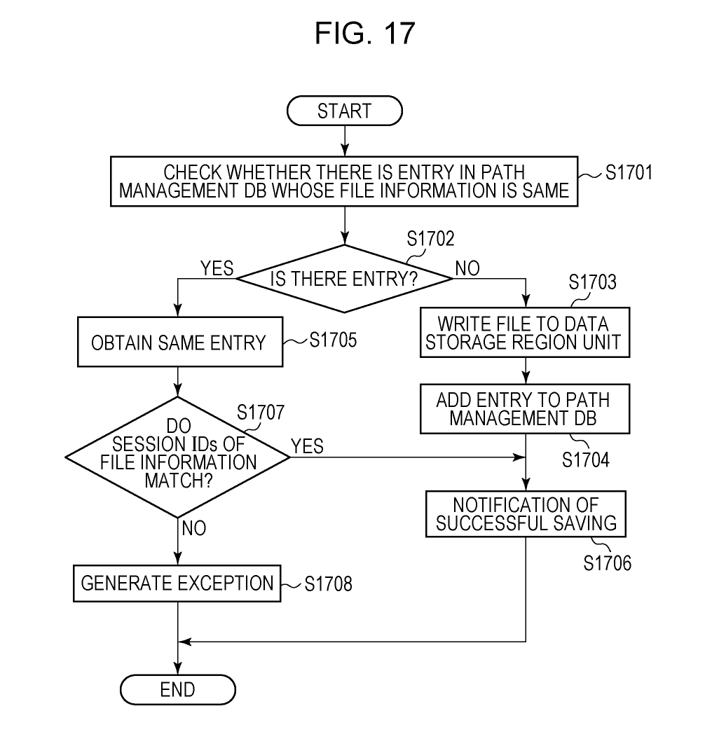

A subsequent process will be described with reference to a flowchart of FIG. 17. In S1701, the overwriting determination processing section 1522 checks whether or not an entry having the same file information exists in the path management DB section 1532. More specifically, file information is regarded as the same when the values of three items, namely the file group ID 1611, the task ID 1612, and the No. 1613, perfectly match. It is to be noted that whether or not file information is the same may be determined on the basis of values other than those of these items. For example, file information may be regarded as the same on the basis of the file group ID 1611 and the task ID 1612. If it is determined in S1702 that no entry having the same file information exists, the overwriting prohibiting file saving section 1511 calls a file saving processing section 1521, and writes a file to the data storage region unit 1541 in S1703. Next, the file saving processing section 1521 adds an entry to the path management DB section 1532 in S1704. The received file (path 1614) and session ID 1619 are associated with the entry and saved. Next, the overwriting prohibiting file saving section 1511 returns a notification of successful saving to the scan service server 101 in S1706. The notification of successful saving is a notification indicating that the file has been successfully saved.

If an entry having the same file information exists in S1702, the overwriting determination processing section 1522 obtains the same entry from the path management DB section 1532 in S1705. The overwriting determination processing section 1522 checks in S1707 whether or not the session ID included in the file information in the request and the session ID 1619 included in the entry obtained in S1705 match. If the session IDs match in S1707, it is determined that the file included in the request has already been saved, and the overwriting prohibiting file saving section 1511 returns a notification of successful saving to the scan service server 101 in S1706. If the session IDs do not match in S1707, the overwriting prohibiting file saving section 1511 determines the request as an overwriting request, and generates an exception in S1708. The scan service server 101 then obtains information indicating the generation of the exception.

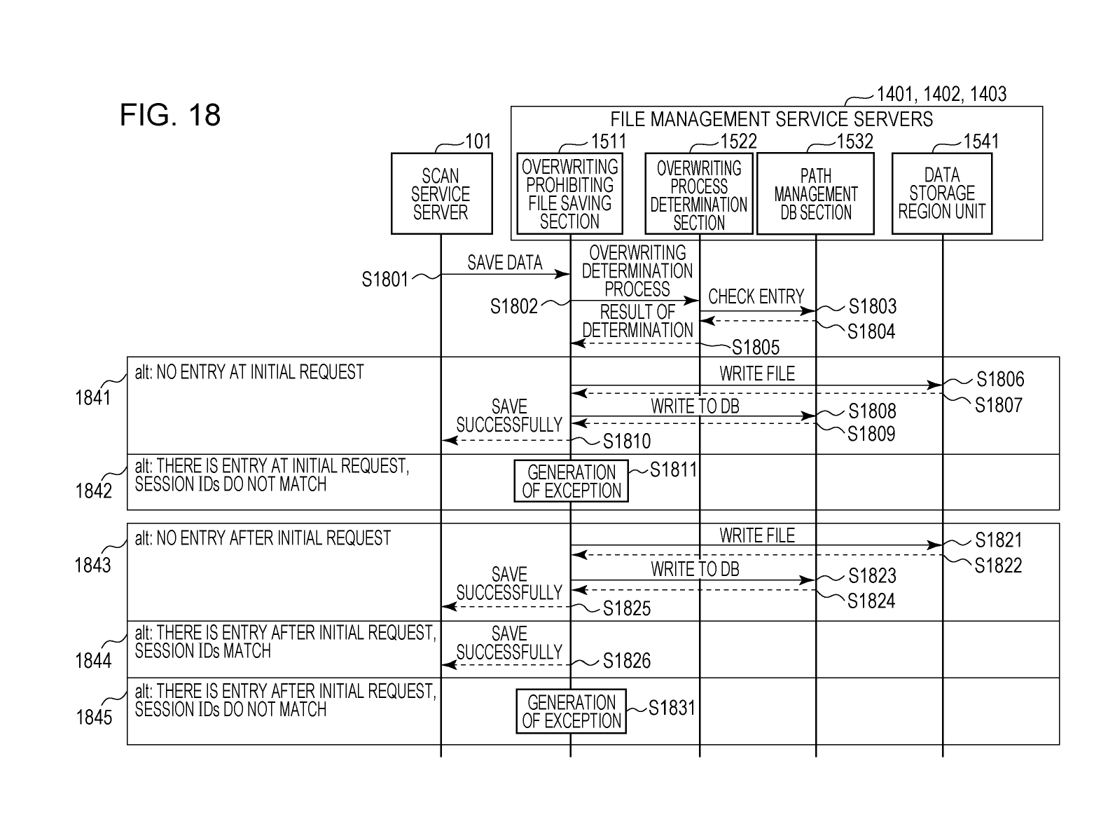

Sequences in which, as a result of the process illustrated in FIG. 17, the scan service server 101 causes the overwriting prohibiting file saving section 1511 to save data will be described with reference to FIG. 18. A sequence at an initial request and a sequence after the initial request will be separately described. The file saving processing section 1521 is omitted for convenience of description.

First, the scan service server 101 makes a data saving request S1801 to the overwriting prohibiting file saving section 1511. Upon receiving the data saving request S1801, the overwriting prohibiting file saving section 1511 performs an overwriting determination process S1802 on the overwriting determination processing section 1522. In S1803, the overwriting determination processing section 1522 checks whether or not the same entry as file information included in the data saving request S1801 already exists in the path management DB section 1532, and returns a result of the determination in S1805.

Cases 1841 and 1842 indicate processing procedures that can be performed in accordance with the result in S1805 when the data saving request S1801 is an initial data saving request.

The case 1841 indicates a processing procedure at a time when the result of the determination in S1805 indicates no entry. The case 1841 corresponds to a case in which the data saving request S1801 is not an overwriting request. Therefore, the overwriting prohibiting file saving section 1511 writes a file to the data storage region unit 1541 in file writing S1806, and writes an entry to the path management DB section 1532 in a DB writing process S1808. Thereafter, the overwriting prohibiting file saving section 1511 returns a response of a notification of successful saving S1810 to the scan service server 101.

The case 1842 indicates a processing procedure at a time when the result of the determination in S1805 indicates that there is an entry but the session IDs do not match. The case 1842 corresponds to a case in which the data saving request S1801 is an overwriting request. Therefore, in S1811, the overwriting prohibiting file saving section 1511 generates an exception indicating that the file already exists. The case 1842 is the same as a case in which the data saving request S1020 has been made in FIG. 10. That is, the initial request in the case 1842 means that the request is an initial request for an apparatus (the third-party application server 1001 in the case of FIG. 10) that is saving a file.

It is to be noted that in the case of an initial request, there can be no case in which there is an entry and session IDs match. That is, for example, the third-party application server 1001 or the like cannot obtain the session ID of an already existing entry. Therefore, the third-party application server 1001 or the like cannot specify the session ID of an already existing entry as a session ID of file information, and accordingly the session IDs do not match.

Cases 1843 to 1845 indicate processing procedures that can be performed in accordance with the result in S1805 when the data saving request S1801 is a data saving request after the initial request.

The case 1843 indicates a processing procedure at a time when the result of the determination in S1805 indicates no entry. This case corresponds to a case in which an entry has not been successfully created at the initial request and accordingly a retry is performed. In this case, the overwriting prohibiting file saving section 1511 writes a file to the data storage region unit 1541 in file writing S1821. Next, the overwriting prohibiting file saving section 1511 writes an entry to the path management DB section 1532 in a DB writing process S1823, and then returns a response of a notification of successful saving S1825 to the scan service server 101.

The case 1844 indicates a processing procedure at a time when the result of the determination in S1805 indicates that there is an entry and the session IDs match. The case 1844 corresponds to a case in which the file to be saved has already been saved by a past saving request. Therefore, unlike the case 1843, the overwriting prohibiting file saving section 1511 returns a response indicating a notification of successful saving S1826 to the scan service server 101 without performing the process for saving a file. The problem that an exception is undesirably generated by the data saving request S920 has been described with reference to FIG. 9 at the beginning of this description. The data saving request S920 illustrated in FIG. 9 is a retry process for the initial data saving request S911, and since saving of a file and creation of an entry have been successfully completed in S914 to S917, it is undesirable that an exception is generated in S923. By following the process illustrated in FIG. 17, a response of successful saving can be returned to the scan service server 101 in S1826.

The case 1845 indicates a processing procedure at a time when the result of the determination in S1805 indicates that there is an entry and the session IDs do not match. The case 1845 corresponds to a case in which the data saving request S1801 is an overwriting request. Therefore, in S1831, the overwriting prohibiting file saving section 1511 generates an exception indicating that the file already exists. The scan service server 101 then obtains information indicating the generation of the exception. The case 1845 corresponds to a case in which, for example, the third-party application server 1001 makes a data saving request again even after the case 1842.

As in the case 1841 to 1845, notification of successful saving and generation of an exception can be performed in a desirable manner by following the process illustrated in FIG. 17.

Referring back to FIG. 15, the overwriting permitting file saving section 1513 will be described next. The overwriting permitting file saving section 1513 realizes a function of multiplexing and saving a file in the data storage region unit 1541 of each of the file management service server A 1401 to the file management service server X 1403 in accordance with a request from the task service server 103 or 104. The overwriting permitting file saving section 1513 and the overwriting prohibiting file saving section 1511 are different from each other only in that when there is an entry in the path management DB section 1532, overwriting of the file and the entry is permitted or prohibited. As with the request from the scan service server 101 to the overwriting prohibiting file saving section 1511, the request from the task service server 103 or 104 to the overwriting permitting file saving section 1513 includes binary data regarding file information and a temporary file. In addition, in the case of the overwriting permitting file saving section 1513, the session ID 1619 need not be included in the file information.

Upon receiving the request from the task service server 103 or 104, the overwriting permitting file saving section 1513 transfers the request to the file saving processing section 1521. The file saving processing section 1521 writes a file to or updates a file in the data storage region unit 1541 and adds an entry to or updates an entry in the path management DB section 1532, and finally returns a notification of successful saving to the task service server 103 or 104 that has made the call.

The file obtaining processing section 1523 receives a file obtaining request from the task service server 103 or 104 through the file obtaining section 1512. Upon receiving the file obtaining request, the file obtaining processing section 1523 searches the path management DB section 1532 for an entry corresponding to file information included in the request. If there is an entry corresponding to the request in the path management DB section 1532, the file obtaining processing section 1523 obtains a corresponding temporary file from the data storage region unit 1541, and returns the temporary file to the task service server 103 or 104 that has made the call through the file obtaining section 1512.

An advantageous effect produced by the first embodiment is that a desirable response can be returned to the client regardless of whether a request to the overwriting prohibiting file saving section 1511 is an initial saving request or a retry saving request.

### Second Embodiment

Assume a case in which, in the first embodiment, the file saving processing section 1521 continues the process for saving a file in the data storage region unit 1541 even after an initial request from the file saving section 521 of the scan service server 101 to the overwriting prohibiting file saving section 1511 is timed out.

Since the initial request has been timed out, the file saving section 521 makes a retry request to the overwriting prohibiting file saving section 1511 again while including, in file information, the same session ID as that of the initial request. At this time, since the file saving processing section 1521 is still writing the file corresponding to the initial request to the data storage region unit 1541, the file that is being written is write-locked. Therefore, writing of a file corresponding to the retry request from the file saving processing section 1521 to the data storage region unit 1541 fails since the file is already write-locked. As a result, the retry request fails, which is problematic.

The procedure of a process for saving a temporary file from the file saving processing section 1521 to the data storage region unit 1541 in this embodiment, that is, the procedure of the processing indicated by S1703 illustrated in FIG. 17, will be described. First, the file saving processing section 1521 issues a unique character string (hereinafter referred to as a postfix) to a file saving request. Next, the file saving processing section 1521 saves the temporary file in the data storage region unit 1541 using a file name, to an end of which the postfix is added. As a result, the temporary file can be saved such that existing file names and a newly saved file name do not overlap. Next, the file saving processing section 1521 adds file information to the path management DB section 1532 as an entry. If the same file information as that included in the request already exists in the path management DB section 1532, the entry is overwritten. The file name of the file information here includes the postfix.

An advantageous effect produced by this embodiment is that, by adding the postfix to the end of a file name, failure of a retry request due to a write-locked file can be avoided.

It is to be noted that although the postfix is added to the end of a file name in this embodiment, a character string may be added to any part of a file name insofar as the resultant file name becomes unique to a request.

### Third Embodiment

If the same entry as file information included in a request already exists when the file information is added to the path management DB section 1532 in the second embodiment, the entry is overwritten. By overwriting the entry in this manner, a temporary file corresponding to the entry before the overwriting undesirably remains in the data storage region unit 1541 as an unnecessary file without being referred to from the entry, thereby consuming the capacity of the data storage region unit 1541.

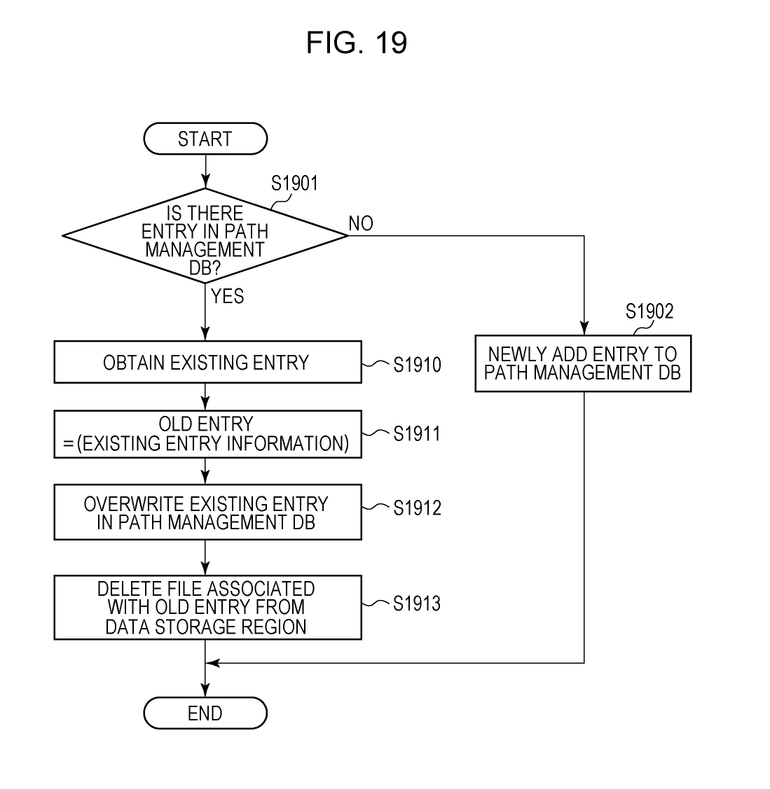

Therefore, in this embodiment, a temporary file corresponding to an entry before overwriting is deleted from the data storage region unit 1541 before an entry from the path management DB section 1532 is used for overwriting. A processing procedure for adding an entry from the file saving processing section 1521 to the path management DB section 1532 according to this embodiment will be described with reference to FIG. 19.

In S1901, the file saving processing section 1521 checks whether or not the same entry as file information included in a request already exists in the path management DB section 1532. If the same entry does not exist in S1901, the file saving processing section 1521 newly adds an entry to the path management DB section 1532. If the same entry exists in S1901, the file saving processing section 1521 obtains the existing entry in S1910, and substitutes the existing entry for an old entry. Next, the file saving processing section 1521 overwrites the existing entry in the path management DB section 1532 with a new entry, and deletes a file associated with the old entry from the data storage region unit 1541.

In the third embodiment, a file that is not referred to from an entry can be deleted, thereby saving the capacity of the data storage region unit 1541.

### Fourth Embodiment

In the first to third embodiments, a case has been assumed in which the scan service server 101 saves initial data in the file management service servers 803. In this embodiment, a case will be assumed in which a task saves initial data in the file management service servers 803. As an example in which a task saves initial data, a case is possible in which the scan service server 101 saves scan data using an external service and, when the image processing described in the first to third embodiment has become necessary, inputs only a job to the job management service server 802. In the job input here, a route is specified that sequentially executes a task that obtains the scan data from the external service and saves the scan data in the file management service servers 803 and a task to be executed by the task service server 103 or 104. In this embodiment, the task that obtains the scan data from the external service and that saves the scan data in the file management service servers 803 will be referred to as a file saving task service server 2140.

In the first to third embodiments, the data saving S714 is performed by the scan service server 101. At this time, for example, it is possible that the scan service server 101 performs both the initial request and the retry process in the same process. If the scan service server 101 performs both the initial request and the retry process in the same process, a session ID of file information at the initial request is stored in processing in the process and then used as a session ID of file information in the retry process. Therefore, the same session ID 1619 can be used in the initial saving request and the retry request. As a result, the retry request to the overwriting prohibiting file saving section 1511 and an overwriting request can be distinguished from each other in S1707, and the type of response can be switched.

On the other hand, if each task fails to save a file, each task is retried on the basis of an upper limit value of the number of retries, which is set for each task. If processing fails, each task notifies the job management service server 802 of the failure, and returns control to the job management service server 802 for the time being. Therefore, processing might be performed using different processes between first execution of the task (initial request) and second execution of the task (retry). As a result, different session IDs of file information might be used between the retry file request and the initial request, or a session ID might not be used. Accordingly, since the retry request to the overwriting prohibiting file saving section 1511 and an overwriting request cannot be distinguished from each other, a correct response cannot be returned to the client.

Therefore, in the fourth embodiment, the job management service server 802 manages jobs and session IDs while associating the jobs and the session IDs with each other.

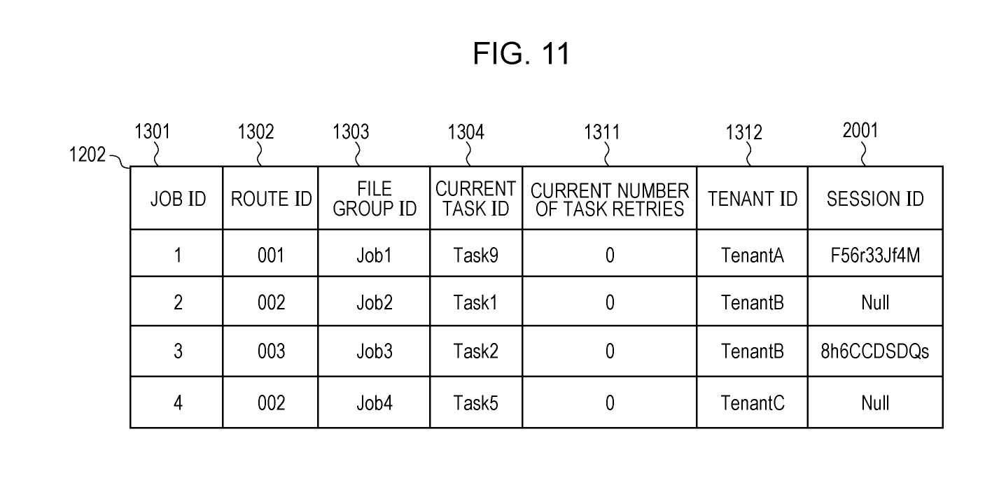

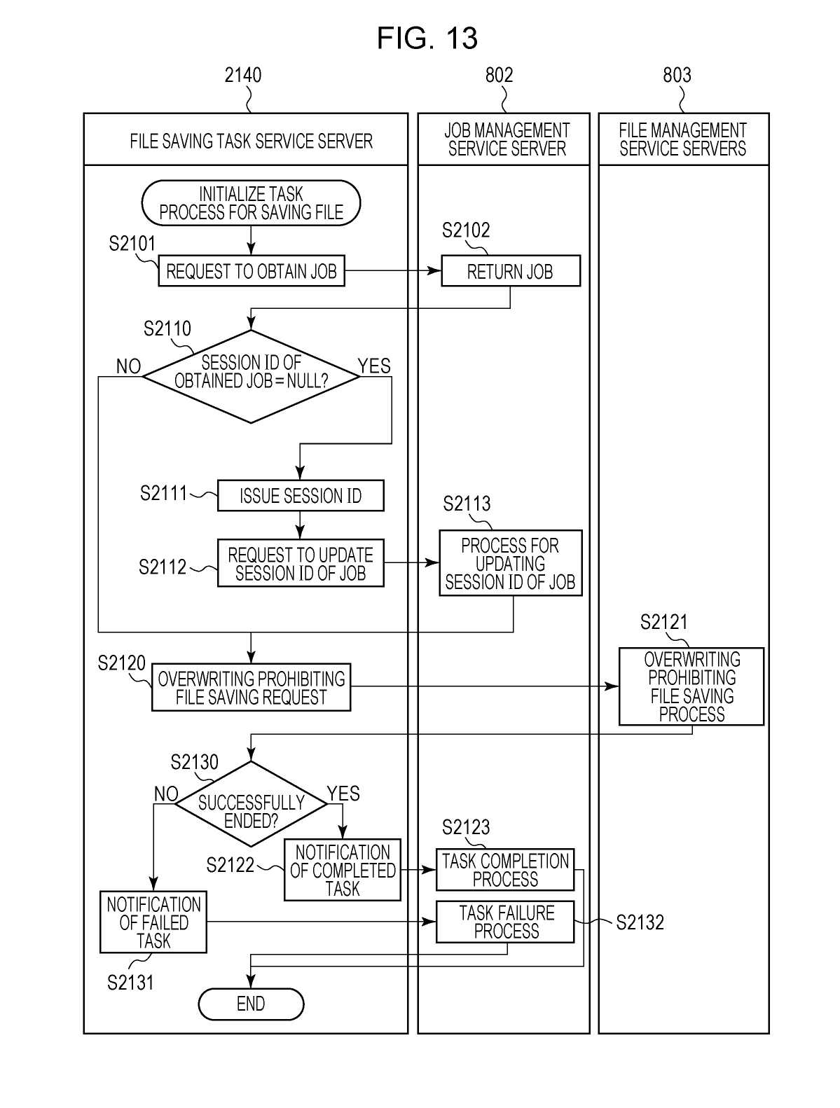

A procedure for saving initial data from the file saving task service server 2140 to the file management service servers 803 will be described with reference to a flowchart of FIG. 13. First, the file saving task service server 2140 makes a job obtaining request to the job management service server 802 in S2101, and the job management service server 802 returns a target job in S2102. FIG. 11 illustrates an example of data managed by the job information management DB unit 1202 according to this embodiment.

The file saving task service server 2140 determines whether or not a session ID 2001 of the obtained job is null. If the session ID 2001 is null, it means that the session ID 2001 has not been issued. If the session ID 2001 is null in S2110, the file saving task service server 2140 issues a session ID in S2111, and requests the job management service server 802 to update the session ID 2001 in S2112. Upon receiving the request to update the session ID 2001, the job management service server 802 updates the session ID 2001 in the job information management DB unit 1202 in S2113.

Next, in S2120, the file saving task service server 2140 makes an overwriting prohibiting file saving request to the overwriting prohibiting file saving section 1511 of one of the file management service server A 1401 to the file management service server X 1403. As the session ID 1619 included in the request in S2120, a character string issued in S2111 is used if the session ID 2001 is null in S2110, or a character string of the session ID 2001 is used if the session ID 2001 is not null. Thus, by managing information relating to the session ID 2001 using the job information management DB unit 1202, the same session ID can be used in each process performed by the file saving task service server 2140.

In an overwriting prohibiting file saving process S2121, the same processing as that illustrated in FIG. 17 is performed. At this time, as in the first embodiment, the values of the three items, namely the file group ID 1611, the task ID 1612, and the No. 1613, are used for determining whether or not file information is the same in S1701 illustrated in FIG. 17. Among these items, the task ID 1612 remains the same even if tasks are different between the initial saving request and the retry request. Therefore, it is determined in S1701 illustrated in FIG. 17 that the file information in the retry request is the same as that in the initial saving request, and accordingly it is determined in S1702 that there is an entry.

After completion of S2121, the file saving task service server 2140 determines in S2130 whether or not the saving process has been successfully completed. If the saving process has been successfully completed in S2130, the file saving task service server 2140 notifies the job management service server 802 of the completion of the task in S2122. The job management service server 802 updates a current task ID 1304, which indicates a current task ID of the job information management DB unit 1202, to a next task in a task completion process S2123.

If the saving process has failed in S2130, the file saving task service server 2140 notifies the job management service server 802 of the failure of the task in S2131. The job management service server 802 increments a current number of task retries 1311, which indicates the number of retries of the task, in a task failure process S2132.

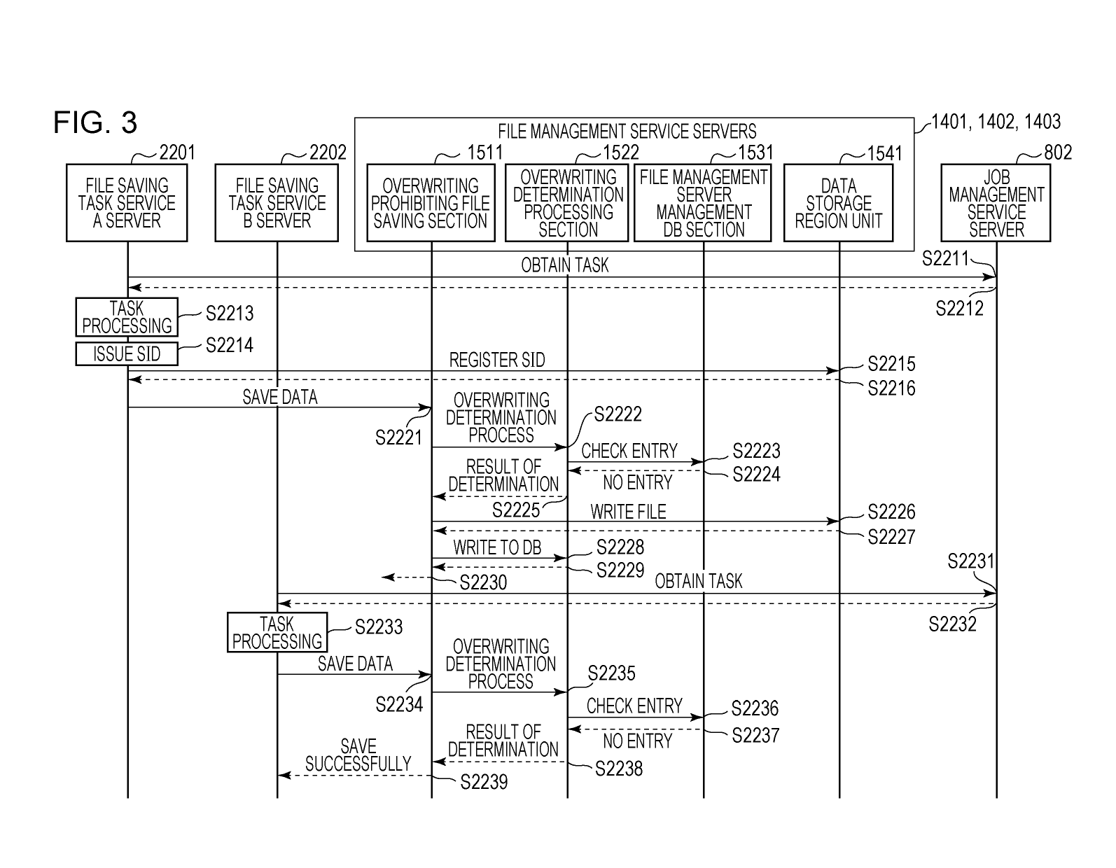

A procedure for saving initial data from a file saving task service A server 2201 and a file saving task service B server 2202 to the file management service servers 803 will be specifically described with reference to a sequence illustrated in FIG. 3. The file saving task service A server 2201 and the file saving task service B server 2202 have the same functions as the file saving task service server 2140 illustrated in FIG. 13, and are task service servers that save processed files in the file management service servers 803 as initial data. The sequence illustrated in FIG. 3 indicates a processing procedure at a time when the file saving task service A server 2201 performs an initial task process and fails to save initial data and the file saving task service B server 2202 performs a retry task process.

First, the file saving task service A server 2201 makes a task obtaining request S2211 to the job management service server 802, and the job management service server 802 returns a task to be processed by the file saving task service A server 2201 in S2212. The file saving task service A server 2201 performs a task process S2213, and saves a file generated as a result of the task process S2213 in the file management service servers 803 as initial data.

Since the task process S2213 is an initial task process, the session ID 2001, which is an element of job information included in the response S2212 from the job management service server 802, is null. Therefore, the file saving task service A server 2201 issues a session ID in S2214, and makes a session ID registration request S2215 to the job management service server 802. The job management service server 802 returns S2216 by registering the session ID issued in S2214 to the session ID 2001 of the job information management DB unit 1202.

After completing the registration of the session ID to the job information management DB unit 1202, the file saving task service A server 2201 makes an initial data saving request S2221 to the overwriting prohibiting file saving section 1511. Upon receiving the initial data saving request S2221, the overwriting prohibiting file saving section 1511 performs, in S2222 to S2229, the same process for saving a file as that in S1802 to S1809, and tries to return a response of a notification of successful saving S2230 to the file saving task service A server 2201. If connection between the file saving task service A server 2201 and the file management service servers 803 is timed out because it has taken a long time to complete the process for saving a file, however, the response of the notification of successful saving S2230 cannot be returned.

Therefore, this time, the file saving task service B server 2202 makes a task obtaining request S2231 to the job management service server 802, and the job management service server 802 returns a task to be processed by the file saving task service B server 2202 in S2232. The file saving task service B server 2202 performs a task process S2233, and saves a file generated as a result of the task process S2233 in the file management service servers 803 as initial data.

Since the task process S2233 is a retry task process, the session ID issued by the file saving task service A server 2201 in S2214 is set as the session ID 2001 included in the response S2212 from the job management service server 802. Therefore, the file saving task service B server 2202 makes an initial data saving request S2234 to the overwriting prohibiting file saving section 1511 using this session ID.

Upon receiving the initial data saving request S2234, the overwriting prohibiting file saving section 1511 performs, in S2235 to S2238, the same overwriting determination process as that when the result of the determination in S1802 to S1805 illustrated in FIG. 18 indicates no entry. Because a result of a determination in S2238 corresponds to the case in which there is an entry and the session IDs match, that is, the case 1844 illustrated in FIG. 18, the overwriting prohibiting file saving section 1511 returns a response of a notification of successful saving S2239 to the file saving task service B server 2202.

It is to be noted that although the initial task process S2213 and the retry task process S2233 are performed by different file saving task service servers in this embodiment, the same file saving task service server may perform these processes, instead. When there are a plurality of file saving task service servers, a file saving task service server can continue processing even if another file saving task service server stops, which improves usability.

According to the fourth embodiment, even when a task makes an initial data saving request to the overwriting prohibiting file saving section 1511, a correct response can always be obtained from one of the file management service server A 1401 to the file management service server X 1403.

It is to be noted that the file saving task service server 2140, the job management service server 802, and the file management service servers 803 described in this embodiment may be executed as virtual servers on a single server.

### Other Embodiments

In addition, the present invention is realized by executing the following process.

That is, the present invention is realized by executing a process in which software (program) that realizes the functions of each of the above embodiments is supplied to a system or an apparatus through a network or one of various storage media and a computer (or a CPU, a multiprocessor unit (MPU), or the like) of the system or the apparatus reads and executes the program.

According to the present invention, even if, for example, connection to a component that has transmitted a file becomes no longer available and a file is received again as described with reference to the above-described problem, information indicating that the file has already been saved can be transmitted.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-122460 filed Jun. 11, 2013, which is hereby incorporated by reference herein in its entirety.

What is claimed is:

1. An information processing apparatus comprising:
a reception unit configured to receive a file and file information that includes an identifier and that is relating to the file;
a first determination unit configured to determine, based on the file information, whether the file has been saved;
a saving unit configured to save, if the first determination unit determines based on the file information that the file has not been saved, the file and the file information including the identifier while associating the file and the file information including the identifier with each other;
a second determination unit configured to determine, if the first determination unit determines based on the file information that the file has been saved, whether the identifier saved by the saving unit and an identifier newly received by the reception unit are the same; and
a transmission unit configured to transmit, if the second determination unit determines that the identifier saved by the saving unit and the identifier newly received by the reception unit are the same, information indicating that the file received by the reception unit has been saved.

2. The information processing apparatus according to claim 1,
wherein, if the second determination unit determines that the identifier saved by the saving unit and the identifier newly received by the reception unit are not the same, the transmission unit notifies of an error.

3. The information processing apparatus according to claim 1,
wherein the reception unit receives an identifier for identifying a session,
wherein the saving unit saves the file, the file information, and the identifier for identifying the session while associating the file, the file information, and the identifier for identifying the session with one another, and
wherein the second determination unit determines whether the identifier for identifying the session saved by the saving unit and an identifier newly received by the reception unit are the same.

4. The information processing apparatus according to claim 1,
wherein the reception unit receives an identifier for identifying a job and an identifier for identifying a task included in the job from the task as the file information, and
wherein the first determination unit determines whether the file has been saved based on whether the identifier for identifying the job and the identifier for identifying the task included in file information newly received by the reception unit are included among identifiers for identifying jobs and identifiers for identifying tasks included in file information saved by the saving unit.

5. The information processing apparatus according to claim 1,
wherein the saving unit saves the file using a file name that does not overlap with an existing file name.

6. The information processing apparatus according to claim 5, further comprising:
a deletion unit configured to delete, among files saved by the saving unit, a file that is not referred to in a database.

7. The information processing apparatus according to claim 1, further comprising:
a third determination unit configured to determine whether an identifier for identifying a session of a job has been issued; and
an issuing unit configured to issue, if the third determination unit determines that the identifier for identifying the session of a job has not been issued, the identifier for identifying the session of a job,
wherein the saving unit saves the file, the file information, and the identifier for identifying the session of a job issued by the issuing unit while associating the file, the file information, and the identifier for identifying the session of a job with one another.

8. A control method for an information processing apparatus, the comprising:
receiving a file and file information that includes an identifier and that is relating to the file;
determining, based on the file information, whether the file has been saved;
saving, if it is determined based on the file information that the file has not been saved, the file and the file information including the identifier while associating the file and the file information including the identifier with each other;
determining, if it is determined based on the file information that the file has been saved, whether the saved identifier and a newly received identifier are the same; and
transmitting, if it is determined that the saved identifier and the newly received identifier are the same, information indicating that the received file has been saved.

9. The control method according to claim 8,
wherein, it is determined that the saved identifier and the newly received identifier are not the same, transmitting includes notifying of an error.

10. The control method according to claim 8,
wherein receiving includes receiving an identifier for identifying a session,
wherein saving includes saving the file, the file information, and the identifier for identifying the session while associating the file, the file information, and the identifier for identifying the session with one another, and
wherein determining includes determining whether the identifier for identifying the saved session and a newly received identifier are the same.

11. The control method according to claim 8,
wherein receiving includes receiving an identifier for identifying a job and an identifier for identifying a task included in the job from the task as the file information, and
wherein determining includes determining whether the file has been saved based on whether the identifier for identifying the job and the identifier for identifying the task included in newly received file information are included among identifiers for identifying jobs and identifiers for identifying tasks included in saved file information.

12. The control method according to claim 8,
wherein saving includes saving the file using a file name that does not overlap with an existing file name.

13. The control method according to claim 12, further comprising:
deleting, among saved filed, a file that is not referred to in a database.

14. The control method according to claim 8, further comprising:
determining whether an identifier for identifying a session of a job has been issued; and
issuing, if it is determined that the identifier for identifying the session of a job has not been issued, the identifier for identifying the session of a job,
wherein saving includes saving the file, the file information, and the identifier for identifying the session of an issued job while associating the file, the file information, and the identifier for identifying the session of a job with one another.

15. A system comprising:
a reception unit configured to receive a file and file information that includes an identifier and that is relating to the file;
a first determination unit configured to determine, based on the file information, whether the file has been saved;
a saving unit configured to save, if the first determination unit determines based on the file information that the file has not been saved, the file and the file information including the identifier while associating the file and the file information including the identifier with each other;
a second determination unit configured to determine, if the first determination unit determines based on the file information that the file has been saved, whether the identifier saved by the saving unit and an identifier newly received by the reception unit are the same; and
a transmission unit configured to transmit, if the second determination unit determines that the identifier saved by the saving unit and the identifier newly received by the reception unit are the same, information indicating that the file received by the reception unit has been saved.
